(19) United States
(12) Patent Application Publication
(10) Pub. No.: US 2021/0287553 A1
(43) Pub. Date: Sep. 16, 2021

(54) METHOD FOR SEARCHING FOR OPTIMAL ROUTE OF UNMANNED AERIAL VEHICLE, AND SERVER AND SYSTEM FOR SEARCHING FOR OPTIMAL ROUTE

(71) Applicant: Joong Hie WON, Uijeongbu-si (KR)

(72) Inventor: Joong Hie WON, Uijeongbu-si (KR)

(21) Appl. No.: 16/321,432

(22) PCT Filed: Jul. 28, 2017
(86) PCT No.: PCT/KR2017/008177

§ 371 Date: Jan. 28, 2019

(30) Foreign Application Priority Data
Jul. 28, 2016 (KR) 10-2016-0096444

(51) Int. Cl. G08G 5/00; G06Q 10/04; G05D 1/00; B64C 39/02

(52) U.S. Cl. CPC G08G 5/003; G06Q 10/047; G08G 5/006; B64C 2201/127; G05D 1/0038; B64C 39/024; B64C 2201/123; G08G 5/0086

(57) ABSTRACT

A method, an apparatus, and a system for searching for an optimal route are disclosed. An optimal route search server comprises: a navigation information receiving unit for receiving, from a user terminal, location information of a destination and fuselage information of an unmanned aerial vehicle; an optimal route search unit for searching for an optimal route from takeoff to a destination on the basis of the location information of the destination, fuselage information of the unmanned aerial vehicle, and environment information; and a navigation information transmission unit for transmitting navigation information including the optimal route to the user terminal of the unmanned aerial vehicle, thereby providing an optimal flight route.

### TECHNICAL FIELD

The present invention relates to an optimal path search method, an optimal path search server and a system of an unmanned aerial vehicle.

### BACKGROUND ART

Drones is an unmanned aerial vehicle that can fly and steer by guiding radio waves. At first, it was mainly used for military use, but now it is used in various industrial fields such as sports broadcast, disaster scene shooting, exploration report and delivery service, and commercial drone market is growing very rapidly.

In 2015, the drones crash landed in the front yard of the White House, and the drones controlled by domestic imagery team an accident occurred on collided with Duomo cathedral. After this problem, the issue of safety due to drone flight has been highlighted.

The drones are visually controllable within the visible range, but the visible distance is very short (500 m on average) and there is a high risk of accidents due to the mismatch of Visual discrepancy between and the illusion of the pilot.

To solve these problems, FPV (First Person View) system, which shows the first person viewpoint of the drone viewpoint, has been introduced.

A conventional PV (Person View) system transmits an image photographed by a camera attached to a front part of a drone and receives an image as shown in “FIG. 7” through a display screen with a receiver.

Conventional FPV has been as an essential system to perform of industrial drones in the field of entertainment, such as drone's racing and games, because it can provide immersive and realistic feeling as if flying on actual drone.

However, the conventional FPV system is provided in such a manner that only the image transmitted from the front-side camera is displayed as it is or only numerical information is displayed on the image, so it is very important to check the information (altitude, position, speed, etc.) it's difficult to confirm necessary information. Therefore, there is a problem that the probability of a collision or collision of a flight caused by a lack of information or ability of the pilot during the flight of the drones is still high.

In addition, the conventional FPV system merely shows images transmitted from the front-end camera as it is, but does not provide a function of searching for a path for autonomous travel.

### DISCLOSURE

### Technical Problem

It is an object of the present invention to provide an optimal path search method, an optimal path search server and a system considering various environment variables for a stable autonomous flight of a drone.

We propose a method for providing 3D augmented reality flight images for safety, convenience, and efficient flight of drones, and an optimal path search server and system.

It is to be understood, however, that the technical scope of the present invention is not limited to the above-described technical problems, and other technical problems may exist.

### Technical Solution

To solve these technical problems, an aspect of the present invention there is provided a route search server. The route search server includes a navigation information receiving unit for receiving location information of the destination and information on fuselage information from the user terminal; a route search unit for searching for a route from a takeoff to the destination based on a plurality of factors included in the fuselage information and the environment information of the unmanned aerial vehicle; and a navigation information transmitting unit for transmitting a navigation information including the searched route to at least one of the user terminal and the unmanned aerial vehicle.

The route search unit may search the second route on the basis of a third factor included in any one of the fuselage information and the environment information after determining by the second factor that the unmanned aerial vehicle is not possible to fly through the first route and determine whether the unmanned aerial vehicle is possible to fly through the second route on the basis of another factor, besides the third factor. The route search unit may use the mission information of the unmanned aerial vehicle to search for a route from the takeoff to the destination.

The route search unit is configured to determine that the first route is not available based on the third factor based on the third factor included in the fuselage information and the environment information, A second route from the departure point to the destination can be searched for, and a factor different from the third factor can be used to determine whether the unmanned aerial vehicle can fly through the second route.

The environmental information may include topographic altitude information and geo-fence information. The environment information may include weather information including at least one of wind direction, wind speed, field of view, cloudiness, and magnetic field strength, and height information of ground facilities. The fuselage information may include at least one of maximum flight altitude information, flightable time information, battery information, weight information, and flight capability information of the unmanned aerial vehicle.

The route search server further comprises a flight information receiving unit for receiving flight images and flight information taken by the unmanned aerial vehicle from the unmanned aerial vehicle during flight of the unmanned aerial vehicle; an augmented reality flight image generation unit for generating a 3D augmented reality flight image by overlaying a guidance route corresponding to the route searched on the received flight image and the flight information; and an augmented reality flight image transmitting unit for transmitting the 3D augmented reality flight image to the user terminal.

Moreover, the present invention to solve the technical problem, the present invention provides a method for searching route. The route search method is performed by a route search server interlocked with an unmanned aerial vehicle and a user terminal, and comprises receiving location information of the destination and information on fuselage information from the user terminal; searching for a route from a takeoff to the destination based on a plurality of factors included in the fuselage information and the environment information of the unmanned aerial vehicle; and transmitting a navigation information including the searched route to at least one of the user terminal and the unmanned aerial vehicle.

The searching for a route may include searching the first route from the takeoff to the destination on the basis of a first factor included in any one of the fuselage information and the environment information and determining whether the unmanned aerial vehicle is possible to fly through the first route on the basis of a second factor included in any one of the fuselage information and the environment information.

The searching for a route may include searching the second route on the basis of a third factor included in any one of the fuselage information and the environment information after determining by the second factor that the unmanned aerial vehicle is not possible to fly through the first route and determining whether the unmanned aerial vehicle is possible to fly through the second route on the basis of another factor, besides the third factor.

The route search method may further include using the mission information of the unmanned aerial vehicle to search for a route from the source to the destination.

Moreover, in order to solve the above-described technical problems of the present invention, provides a method of searching for an optimal path in another aspect. The optimal path search server, An optimal route search server for searching an optimal route of an unmanned aerial vehicle, comprising: a flight information receiving unit for receiving location information of a destination from a user terminal and information of an unmanned aerial vehicle; An optimal path searching unit for searching for an optimal path from a starting point to the destination based on the position information of the destination, the fuselage information of the unmanned aerial vehicle, And a flight information transmitting unit for transmitting the flight information including the optimal route to the user terminal or the unmanned aerial vehicle. The environment information may be topographic altitude information and geo fence information.

In order to solve the above-described technical problems of the present invention, provides a method of searching for an optimal path in another aspect. The optimal path search method includes: A method for searching an optimal route of an unmanned aerial vehicle, the method comprising: receiving position information of a destination from a user terminal and fuselage information of the unmanned aerial vehicle; Searching for an optimal route from the departure point to the destination point based on the position information of the destination, the fuselage information of the unmanned aerial vehicle and the environment information, And transmitting the flight information including the optimal route to the user terminal or the unmanned aerial vehicle. The environmental information may be terrain altitude information and geo fence information.

In order to solve the above-described technical problems of the present invention, provides a method of searching for an optimal path in another aspect The optimal path search system may include an optimal path search server and a user terminal. Wherein the optimal path search server comprises: An optimal route from the departure point to the destination is searched based on the position information of the destination, the fuselage information of the unmanned aerial vehicle and the environment information, Receiving a flight image and flight information taken by the unmanned aerial vehicle from the unmanned aerial vehicle, And generate a 3D augmented reality flight image by overlaying the guidance route corresponding to the optimal route and the flight information on the received flight image. The user terminal comprises: Receiving the 3D augmented reality flight image from the optimal path search server and outputting the 3D augmented reality flight image, And may be configured to control the unmanned aerial vehicle through the 3D augmented reality flight image.

### Advantageous Effects

According to any one of the means for solving the problems of the present invention,

It is possible to provide an optimal path search method, an optimal path search server and a system considering various environment variables for stable autonomous driving of the drone.

In addition, for safe, comfortable and efficient flight of the drones, A method for providing a 3D ARF (augmented reality flight)-based flight image, and an optimal path search server and system can be provided.

### DESCRIPTION OF DRAWINGS

FIG. 1 is a configuration diagram of an optimal path search system according to an embodiment of the present invention.

FIG. 2 is a block diagram illustrating a configuration of an optimal path search server according to an embodiment of the present invention.

FIG. 3 is a diagram illustrating an augmented reality flight image according to an embodiment of the present invention.

FIG. 4 is a diagram illustrating an augmented reality flight image according to another embodiment of the present invention.

FIG. 5 is a flowchart illustrating an optimal path search method according to an embodiment of the present invention.

FIG. 6 is a flowchart illustrating an optimal path search method according to another embodiment of the present invention.

FIG. 7 is a diagram illustrating a conventional FPV (First Person View) system

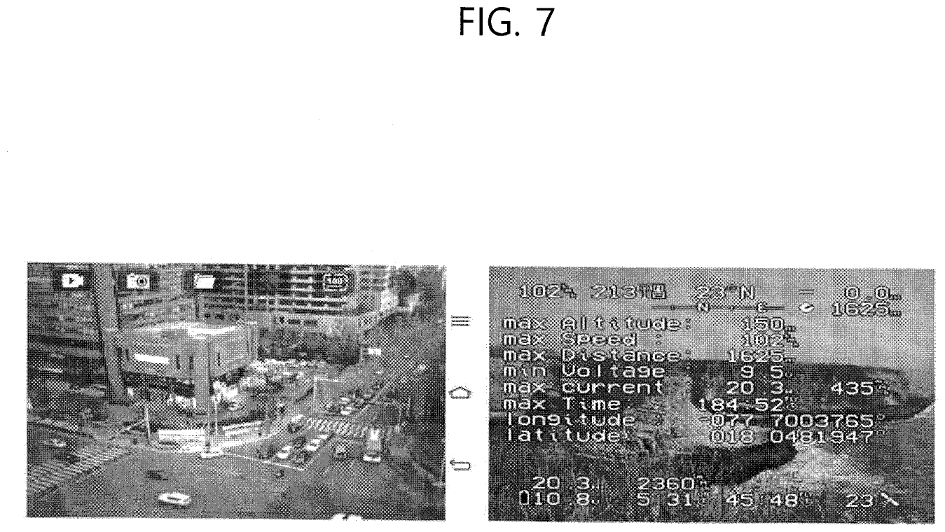

### MODE FOR INVENTION

Hereinafter, embodiments of the present invention will be described in detail with reference to the accompanying drawings, which will be readily apparent to those skilled in the art.

The present invention may, however, be embodied in many different forms and should not be construed as limited to the embodiments set forth herein.

In order to clearly illustrate the present invention, parts not related to the description are omitted, and similar parts are denoted by like reference characters throughout the specification

Throughout the specification, When a part is said to be “connected” to another part, this is not only the case of “direct connection” but also includes the case of being & quot; electrically connected & quot; with another element in between in the middle.

Also, when a section “includes” an element, This does not exclude other components unless specifically stated otherwise But may include other components, But do not preclude the presence or addition of one or more other features, integers, steps, operations, elements, parts, or combinations thereof.

In this Description, “unit”, Unit realized by hardware, Unit realized by software, And includes units realized using both sides. Further, one unit may be realized by using two or more hardware, or two or more units may be realized by one hardware.

In this Description, some of the operations or functions described as being performed by the terminal or the device may be performed in the server connected to the terminal or the device instead. Similarly, some of the operations or functions described as being performed by the server may also be performed on a terminal or device connected to the server.

Hereinafter, embodiments of the present invention will be described in detail with reference to the accompanying figures.

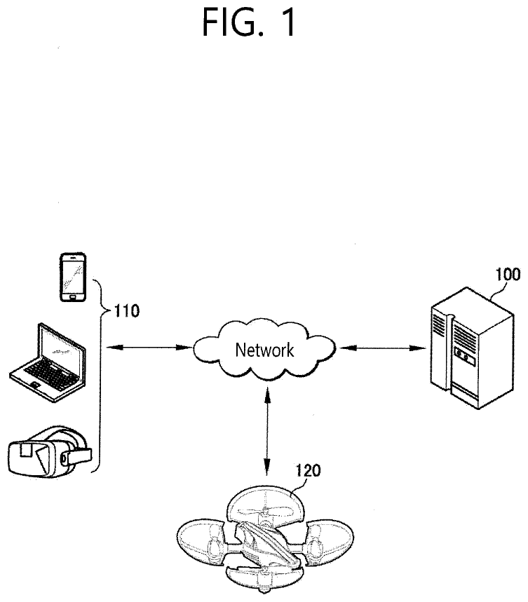

FIG. 1 is a configuration diagram of an optimum path search system according to an embodiment of the present invention. Referring to FIG. 1, the optimal path search system may include an optimal path search server (100) and a user terminal (110). Also, the optimal path search system may include the unmanned aerial vehicle (120).

The optimal path search server 100, the user terminal (110), and the unmanned aerial vehicle (120) can communicate through a network. A network refers to a connection structure in which information can be exchanged between nodes such as terminals and servers, Examples of such a network (120) include the Internet, a wireless LAN (Local Area Network), a WAN (Wide Area Network), a PAN (Personal Area Network), a 3G, a Long Term Evolution (LTE), World Interoperability for Microwave Access (WiMAX), WiGig (Wireless Gigabit), and the like. But is not limited thereto.

The unmanned aerial vehicle (120) is an unmanned aerial vehicle (UAV) capable of flying remotely without a pilot, and has a photographing module for photographing. In addition, the unmanned aerial vehicle (120) includes three-axis gyroscopes for measuring the rotational motion defined by yaw, pitch, and roll, three-axis acceleration sensors, three—It is equipped with magnetometers. In addition, the unmanned aerial vehicle (120) includes a GPS module and a barometric pressure sensor for measuring the translational motion state.

The unmanned aerial vehicle (120) may receive flight information including an optimal route from the optimal route search server (100) or the user terminal (110). The unmanned aerial vehicle (120) can fly based on the optimal route. The unmanned air vehicle (120) can transmit the flight image and the flight information photographed through the camera of the unmanned aerial vehicle (120) to the optimal route search server (100).

One example of the user terminal (110) is a wireless communication device that is guaranteed to be portable and mobility and includes a PCS (Personal Communication System), a Global System for Mobile communications (GSM), a Personal Digital Cellular (PDC), a Personal Handyphone System (Personal Digital Assistant), IMT (International Mobile Telecommunication)-2000, CDMA (Code Division Multiple Access)-2000, W-CDMA (W-CDMA), Wibro (Wireless Broadband Internet) A handheld-based wireless communication device such as a smart card, a smart pad, a tablet PC, a VR (Virtual Reality) device, A head mounted display (HMD), and the like.

The user terminal (110) may control the drones. For example, the user terminal (110) transmits the location information of the destination and the fuselage information of the unmanned aerial vehicle to the optimal route search server (100), and obtains the location information of the unmanned airplane based on the location information of the destination, You can request an optimal route to your destination. Alternatively, the user terminal (110) may directly search for and determine the path of the drones.

The user terminal (110) can receive and output the 3D augmented reality flight image from the optimal path search server (100). The user terminal (110) can control the unmanned aerial vehicle 120 through the 3D augmented reality flight.

The optimal path search server 100 can search for and determine the flight path of the drones.

For example, the location information of the destination and the fuselage information of the unmanned airplane 120 are received from the user terminal 110, and based on the location information of the destination, the fuselage information of the unmanned aerial vehicle 120, and environment information, It is possible to search for the optimal path of the path.

The optimal path search server (100) may transmit the flight information including the optimal path to the user terminal (110) or the unmanned aerial vehicle (120) to allow the unmanned aerial vehicle (120) to fly through the optimal path.

The optimal route search server (100) can receive the flight image and the flight information taken by the unmanned air vehicle (120) from the unmanned aerial vehicle (120) while the unmanned aerial vehicle 120 is in flight.

The optimal path search server (100) can generate a 3D augmented reality flight image by overlaying the guidance route and the flight information corresponding to the optimal route on the received flight image. The optimal path search server (100) may transmit the 3D augmented reality flight image to the user terminal (120).

Hereinafter, each configuration of the optimal path search server (100) will be described in detail.

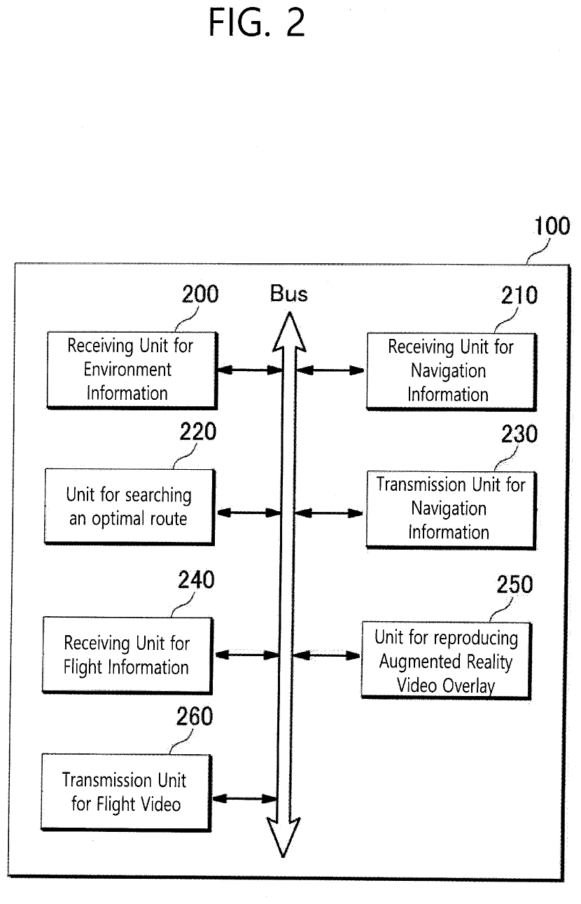

FIG. 2 is a configuration diagram of an optimal path search server according to an embodiment of the present invention. Referring to FIG. 2, the optimal path search server (100) includes an environment information receiving unit (200), a flight information receiving unit (210), an optimal path searching unit (220), a flight information receiving unit (230), a flight information receiving unit (240), An augmented reality flight image generation unit (250), and an augmented reality flight image transmission unit (260).

The environment information receiving unit (200) receives environment information from various external servers and stores the environment information.

The environment information may include a plurality of factors such as weather information, regional altitude information, geo fence information, ground facility information, and the like.

The weather information may include data related to the weather, such as wind direction, wind speed, field of view, cloudiness, and magnetic field strength.

For example, the environment information receiving unit (200) can receive weather data such as wind direction, wind speed, field of view, cloudiness and magnetic field strength from the weather server in real time.

The regional altitude information may include a digital elevation model (DEM). The geofence information may include information about a non-flying zone, a restricted flight zone, a military operation zone, and a flight zone.

The ground facility information may include information on height of a transmission tower, a building, and the like.

For example, the environmental information receiving unit (200) can collect public data, such as a digital map, contour data, building data, etc., and store environmental information.

The flight information receiving unit (210) may receive location information (latitude/longitude data), location information (latitude/longitude data) of the departure location and gas information of the unmanned airplane 120 from the user terminal (110).

Herein, the gas information of the unmanned aerial vehicle (120) may include the maximum flying height of the unmanned aerial vehicle (120), the available flight time, the battery capacity, and the weight of the aircraft.

The flight information receiving unit (210) may further receive the mission information of the unmanned aerial vehicle (120).

The mission information may include, for example military, logistics, exploration, emergency transport, and the like.

The optimal path searching unit (220) can search for an optimal path from the origin to the destination based on the location information of the destination, the fuselage information of the unmanned aerial vehicle (120), and environment information.

That is, the optimum path searching unit (220) can search for a path from the departure point to the destination point based on a plurality of factors included in the fuselage information and environment information of the unmanned aerial vehicle.

Here, the terrain height information, the geofence information, the weather information, and the height information of the ground facilities included in the environment information may have predetermined priorities or different weights.

The optimal path search unit (220) searches

For example, the optimal path can be searched using the Dijkstra algorithm, considering the priorities of the environment information or different weights.

For example, the optimum path searching unit (220) searches for a first path from a start point to a destination based on a first factor included in any one of the fuselage information and the environment information, It is possible to determine whether or not the unmanned aerial vehicle can fly through the first route based on the second factor included in the first route.

If it is determined that the flight through the first route is impossible based on the determination based on the second factor, the optimal route search unit (220) searches for a route based on the third factor included in any one of the fuselage information and the environment information, To determine whether or not the unmanned aerial vehicle can fly through the second route by using a different factor from the third factor.

According to an embodiment of the present invention, the optimal path searching unit (220) searches for a first optimum path from a source point to a destination,

that is, a first path, based on the terrain height information, the height of the ground facility, and the geofence information.

That is, at least one of the height of the ground facility and the geofence information is used as a first factor.

For example, the optimal path searching unit (220) can search for the first-order optimal path based on the geophysical information, taking into account the terrain height information and the height of the ground facilities, (Step 1—Consider terrain elevation information, height of ground facilities and geofence information)

According to another embodiment of the present invention, the optimal path searching unit (220) may search the first optimal path by considering the gas information of the unmanned aerial vehicle (120) first.

Generally, there are many obstacles such as a transmission tower, a building, and a mountain over a high altitude (for example, 50 m or less) higher than a high altitude (for example, 100 m or more).

Therefore, the higher the altitude, the more advantageous to search for the optimal path, and the risk that the unmanned aerial vehicle (120) collides with the obstacle can be reduced.

Accordingly, the optimal path searching unit (220) can search for the optimal path at the maximum flight altitude of the unmanned aerial vehicle (120).

At this time, since the battery consumption is much worse at the time of high altitude flying, the optimum path searching unit (220) may consider the battery capacity additionally.

Thereafter, the optimal path searching unit (220) determines whether or not the flight can be performed through the primary optimal route searched based on the weather information.

That is, the weather information is used as the second factor.

For example, the optimal path searching unit (220) may determine that the flight can not be performed through the primary optimum path when the wind speed is equal to or greater than a preset value or when the view can not be secured according to the cloudiness.

In addition, when the magnetic field strength is equal to or greater than the predetermined value, the optimal path searching unit (220) is highly likely to lose communication with the optimal path search server (100) and the user terminal (110), (Step 2—Consider weather information).

Thereafter, the optimal path searching unit (220) determines whether it is possible to fly through the first optimum path based on the fuselage information of the unmanned aerial vehicle (120).

For example, the optimal path searching unit (220) can determine whether it is possible to fly to the destination through the primary optimum path that is searched based on the battery capacity and the available flight time of the unmanned aerial vehicle (120).

In addition, it is assumed that the weather is poor in the second stage and the wind speed is high.

Generally, when the weight of the unmanned aerial vehicle (120) is heavy or the ability of the unmanned air vehicle (120) to fly is good, the flight stability is excellent.

Accordingly, when the wind speed is high, the optimal path searching unit (220) can determine whether it is possible to fly to the destination through the first optimum path based on the weight and the flying ability of the unmanned air vehicle (120) (Step 3—Information).

According to another embodiment of the present invention, the optimal path searching unit (220) may search for an optimal path based on the mission information of the unmanned aerial vehicle (120).

Mission information may include, for example, military, logistics, exploration, emergency transport, and the like.

For example, when the unmanned aerial vehicle 120 is performing the first mission (for example, an urgent transportation mission), the optimal path searching unit 220 may determine the shortest path as the optimum path for quickness.

For example, when the unmanned aerial vehicle 120 is performing the second mission (e.g., military, exploration), the optimal path searching unit 220 may determine a safe path as an optimal path for stability.

If it is determined that it is impossible to fly to the destination through the first optimum route (i.e., the first route) found in step 3, The optimal path search unit 220 searches for a secondary optimal path,

That is, the second path may be searched and the first through third steps may be performed.

In this manner, the optimum path is searched in consideration of various environmental information and the fuselage information of the unmanned aerial vehicle (120), thereby maximizing the energy efficiency and extending the flying distance and the flying time of the unmanned aerial vehicle (120).

The flight information transmission unit (230) may transmit the flight information including the optimal route to the user terminal (110) or the unmanned aerial vehicle (120).

Herein, the flight information may include a forecasted battery consumption rate, a flight expected flight time, a route distance, and the number of nodes (Wn) on the route.

The flight information receiver (240) can receive the flight image and the flight information taken by the unmanned air vehicle (120) from the unmanned air vehicle (120) while the unmanned air vehicle (120) is in flight. The flight information may include, for example, the altitude, location and speed of the unmanned aerial vehicle.

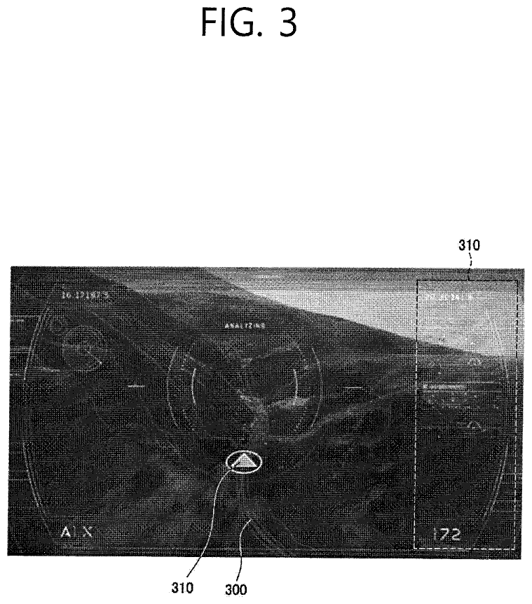

The augmented reality flight image generation unit (250) generates a three-dimensional augmented reality image by overlaying the optimal path (300) and the flight information (310) on the received flight image, as exemplarily shown in FIG. 3.

Here, the flight information may include altitude, position and speed of the unmanned aerial vehicle (120), and the like.

In addition, the augmented reality flight image generation unit (250) may display an icon (320) indicating the unmanned aerial vehicle (120 on the optimal path (300).

In addition, the augmented reality flight image generation unit 250 generates augmented reality

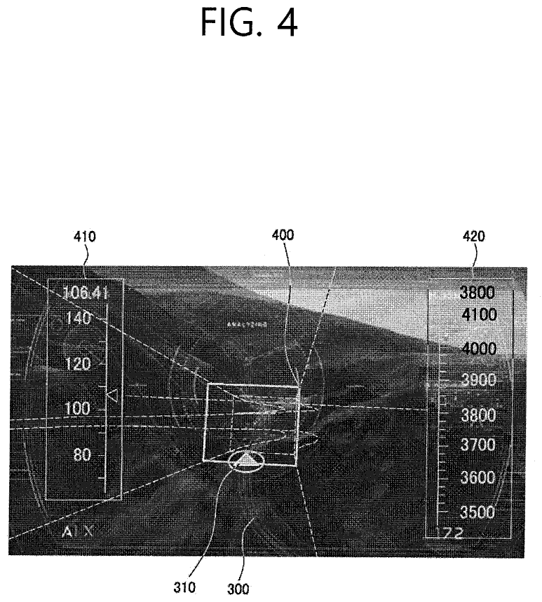

For example, as illustrated in FIG. 4, a 3D augmented reality image can be generated by overlaying the guidance route (400) on the received flight image.

Also, the augmented reality flight image generation unit (250) may display the speed (410) and the altitude (420) of the unmanned aerial vehicle (120), and the like. The guidance route (400) may be formed in a tunnel frame shape so that the pilot can easily grasp the route in three dimensions.

The augmented reality flight image generation unit (250) may determine the type and arrangement of the information displayed on the 3D augmented reality image based on the mission information of the unmanned aerial vehicle (120).

That is, the types and arrangements of information are configured to correspond to the mission information of the unmanned air vehicle (120).

For example, the augmented reality flight image generation unit (250) confirms the mission information of the drone and assumes that the mission information of the drone is information corresponding to the first mission, It can be displayed on the 3D augmented reality image.

Assuming, for example, that the first task is emergency transport,

Critical flight speed for urgent transport tasks, the remaining distance to the destination in the first position,

For example, a large character, a highlight, or the like may be disposed on the left or right side of the screen to facilitate identification, a guidance route may be disposed in the middle of the screen, and the remaining information may be disposed at other positions.

As mentioned above, the mission information may include, for example, military, logistics, exploration, emergency transport, and the like.

The augmented reality flight image transmission unit (260) can transmit the augmented reality flight image to the user terminal (110).

Accordingly, the user can control the unmanned aerial vehicle (120) by viewing the 3D augmented reality flight image through a VR (Virtual Reality) device.

In this way, unlike the FPV system showing only the conventional simple image, the information necessary for flight can be provided as an intuitive graphic in the form of a 3D augmented reality to improve the cognitive ability of the pilot.

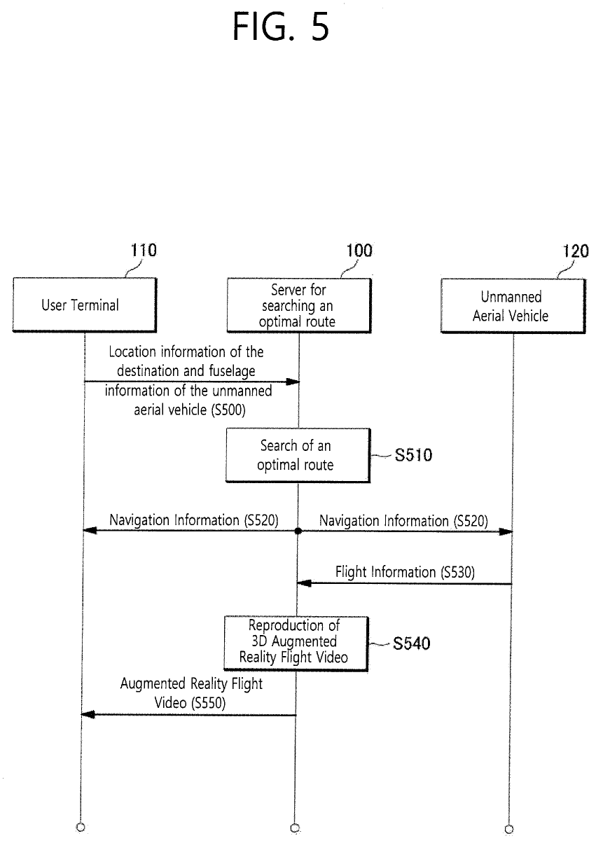

Accordingly, it is possible to reduce the possibility of collision or collision of a flight caused by a lack of information or ability of a pilot. [76] FIG. 5 is a flowchart illustrating an optimal path search method according to an embodiment of the present invention. It is a flow chart showing how to provide to device.

The optimal path search method according to the embodiment shown in FIG. 5 includes steps that are processed in a time-series manner in the system shown in Fig.

Therefore, even if omitted below, the present invention is also applied to an optimal path search method performed according to the embodiment shown in FIG. 5.

In step S500, the user terminal (110) can transmit the location information of the destination and the fuselage information of the unmanned aerial vehicle to the optimal route search server (100).

In step S510, the optimal path search server (100) is It is possible to search for the optimal route from the departure point to the destination point based on the position information of the destination, the fuselage information of the unmanned aerial vehicle (120), the environmental information, and the mission information of the unmanned aerial vehicle (120).

In step S520, the optimal path search server (100) may transmit the flight information including the optimal path to the user terminal (110) or the unmanned air vehicle (120).

In step S530, the unmanned aerial vehicle (120) may transmit the flight image and the flight information captured by the unmanned aerial vehicle (120) to the optimal path search server (100).

In operation S540, the optimal path search server 100 may generate a 3D augmented reality flight image by overlaying the guidance route and the flight information corresponding to the optimal route on the received flight image.

In operation S550, the optimal path search server (100) may transmit the 3D augmented reality flight image to the user terminal (110).

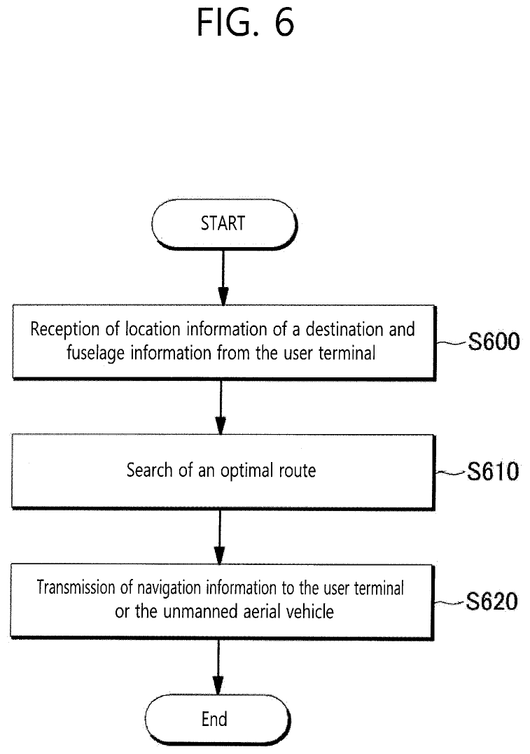

FIG. 6 is a flowchart illustrating an optimal path search method according to another embodiment of the present invention. The optimal path search method according to one embodiment shown in FIG. 6 includes steps that are processed in a time-series manner in the optimal path search server (100) shown in FIG. 1 and FIG. 2.

Therefore, even if omitted below, the present invention is also applied to an optimal path search method performed according to an embodiment shown in FIG. 6.

In step S600, the optimal path search server (100) may receive the location information of the destination and the fuselage information of the unmanned aerial vehicle (120) from the user terminal (110).

In step S610, the optimal path search server (100) transmits,

It is possible to search for the optimal route from the departure point to the destination point based on the position information of the destination, the fuselage information of the unmanned aerial vehicle (120), the environmental information, and the mission information of the unmanned aerial vehicle (120).

In step S620, the optimal path search server (100) may transmit the flight information including the optimal path to the user terminal (110) or the unmanned aerial vehicle (120).

The optimal path search method described with FIG. 5 and FIG. 6 may be implemented in the form of a computer program stored in a medium or in the form of a recording medium including instructions executable by a computer such as a program module executed by a computer.

Computer readable media can be any available media that can be accessed by a computer and includes both volatile and nonvolatile media, removable and non-removable media.

In addition, the computer-readable medium can include both computer storage media and communication media. Computer storage media includes both volatile and nonvolatile, removable and non-removable media implemented in any method or technology for storage of information such as computer readable instructions, data structures, program modules or other data.

Communication media typically includes any information delivery media, including computer readable instructions, data structures, program modules, or other data in a modulated data signal such as a carrier wave, or other transport mechanism.

The description of the invention is intended to be illustrative,

It will be understood by those skilled in the art that various changes in form and details may be made therein without departing from the spirit and scope of the invention as defined by the appended claims.

It will be understood that the invention can be easily modified in other specific forms.

It is therefore to be understood that the above-described embodiments are illustrative in all aspects and not restrictive.

For example, each component described as a single entity may be distributed and implemented, and components described as being distributed may also be implemented in a combined form.

The scope of the present invention is defined by the appended claims rather than the detailed description and all changes or modifications derived from the meaning and scope of the claims and their equivalents are to be construed as being included within the scope of the present invention do.

1. A route search server interlocked with an unmanned aerial vehicle and an user terminal, comprising:
a navigation information receiving unit for receiving location information of the destination and information on fuselage information from the user terminal;
a route search unit for searching for a route from a takeoff to the destination based on a plurality of factors included in the fuselage information and the environment information of the unmanned aerial vehicle; and
a navigation information transmitting unit for transmitting a navigation information including the searched route to at least one of the user terminal and the unmanned aerial vehicle.

2. The route search server of claim 1, wherein the route search unit searches the first route from the takeoff to the destination on the basis of a first factor included in any one of the fuselage information and the environment information and determines whether the unmanned aerial vehicle is possible to fly through the first route on the basis of a second factor included in any one of the fuselage information and the environment information.

3. The route search server of claim 2, wherein the route search unit searches the second route on the basis of a third factor included in any one of the fuselage information and the environment information after determining by the second factor that the unmanned aerial vehicle is not possible to fly through the first route and determines whether the unmanned aerial vehicle is possible to fly through the second route on the basis of another factor, besides the third factor.

4. The route search server of claim 1, wherein the route search unit uses the mission information of the unmanned aerial vehicle to search for a route from the takeoff to the destination.

5. The route search server of claim 1, wherein the environment information includes topography altitude information and geo-fence information.

6. The route search server of claim 1, wherein the environment information includes weather information including at least one of wind direction, wind speed, field of view, cloudiness, and magnetic field strength, and height information of ground facilities.

7. The route search server of claim 1, wherein:
the fuselage information includes at least one of maximum flight altitude information, flightable time information, battery information, weight information, and flight capability information of the unmanned aerial vehicle.

8. The route search server of claim 1, further comprising:
a flight information receiving unit for receiving flight images and flight information taken by the unmanned aerial vehicle from the unmanned aerial vehicle during flight of the unmanned aerial vehicle;
an augmented reality flight image generation unit for generating a 3D augmented reality flight image by overlaying a guidance route corresponding to the route searched on the received flight image and the flight information; and
an augmented reality flight image transmitting unit for transmitting the 3D augmented reality flight image to the user terminal.

9. A method for searching route, performed by the route search server interlocked with an unmanned aerial vehicle and an user terminal, the method comprising:
receiving location information of the destination and information on fuselage information from the user terminal;
searching for a route from a takeoff to the destination based on a plurality of factors included in the fuselage information and the environment information of the unmanned aerial vehicle; and
transmitting a navigation information including the searched route to at least one of the user terminal and the unmanned aerial vehicle.

10. The method of claim 9, wherein the searching for a route comprises searching the first route from the takeoff to the destination on the basis of a first factor included in any one of the fuselage information and the environment information and determining whether the unmanned aerial vehicle is possible to fly through the first route on the basis of a second factor included in any one of the fuselage information and the environment information.

11. A method of claim 10, wherein the searching for a route comprises searching the second route on the basis of a third factor included in any one of the fuselage information and the environment information after determining by the second factor that the unmanned aerial vehicle is not possible to fly through the first route and determining whether the unmanned aerial vehicle is possible to fly through the second route on the basis of another factor, besides the third factor.

12. A method of claim 8, further comprising:
using the mission information of the unmanned aerial vehicle to search for a route from the takeoff to the destination.

13. A route search server for searching route of an unmanned aerial vehicle, comprising:
a receiving unit for receiving from the user terminal, location information of a destination and fuselage information of the unmanned aerial vehicle;
an optimal route search unit for searching for an optimal route from the takeoff to the destination on the basis of multiple factors derived from fuselage information of the unmanned aerial vehicle and environment information; and
a transmission unit for transmitting navigation information including the searched routes to the user terminal and/or the unmanned aerial vehicle wherein:
the environment information includes topography altitude information and geo-fence information.

14. A route search server system according to claim 13, characterized by:
a receiving unit for receiving additionally mission information of the unmanned aerial vehicle and;
a route search unit for searching an optimal route from the takeoff to the destination on the basis of the mission information, location information of the destination, fuselage information of the unmanned aerial vehicle, and weather information.

15. A route search server system according to claim 13, wherein:
the environment information includes weather information and elevation information of the ground facilities;
topography altitude information, geo-fence information, weather information, elevation information of the ground facilities, and fuselation information are predetermined by priority weights; and
the route search unit searches an optimal route by using Dijkstra algorithm given priority weight among topography altitude information, geo-fence information, weather information, elevation information of the ground facilities, and fuselation information.

16. A route search server system according to claim 13, comprising:
a receiving unit for receiving flight information and video taken by the unmanned aerial vehicle during its flight;
a reproduction unit for reproducing 3-dimensional augmented reality guidance along the optimal route searched over the real-time flight video received; and
a transmission unit for transmitting the 3-dimensional augmented reality overlay to the user terminal.

17. A method for searching the optimal route by the route search server system between an unmanned aerial vehicle and an user terminal, including the steps of:
receiving from the user terminal, location information of a destination and fuselage information of the unmanned aerial vehicle;
searching for an optimal route from the takeoff to the destination on the basis of multiple factors derived from fuselage information of the unmanned aerial vehicle and environment information; and
transmitting navigation information including the searched routes to the user terminal and/or the unmanned aerial vehicle;
and characterized by including topography altitude information and geo-fence information for the environment information.

18. A method for searching the optimal route according to claim 17, wherein:
the environment information includes weather information and elevation information of the ground facilities;
topography altitude information, geo-fence information, weather information, elevation information of the ground facilities, and fuselation information are predetermined by priority weights; and
the route search step is characterized by searching an optimal route by using Dijkstra algorithm given priority weight among topography altitude information, geo-fence information, weather information, elevation information of the ground facilities, and fuselation information

19. A method for searching the optimal route according to claim 17, including the steps of:
receiving flight information and video taken by the unmanned aerial vehicle during its flight;
reproducing 3-dimensional augmented reality guidance along the optimal route searched over the real-time flight video received; and

20. A route search unit for an unmanned aerial vehicle including a route search server and an user terminal, wherein:
the route search server is characterized by searching an optimal route from a takeoff to a destination on the basis of location information of the destination, fuselage information of the unmanned aerial vehicle, and environment information;
receives flight information and video taken by the unmanned aerial vehicle; and
reproduces 3-dimensional augmented reality guidance along the optimal route searched over the real-time flight video received; and
the user terminal is characterized by receiving the 3-dimensional augmented reality overlay from the route search server and controlling flight of the unmanned aerial vehicle through the 3-dimensional augmented reality overlay.
